(19) United States
(12) Patent Application Publication
(10) Pub. No.: US 2012/0048844 A1
(43) Pub. Date: Mar. 1, 2012

(54) Resistive heating control for a wind turbine or any permanent magnetic generator

(76) Inventor: Edward E. Paparelli, Cato, NV (US)

(21) Appl. No.: 13/199,246

(22) Filed: Aug. 24, 2011

Related U.S. Application Data
(60) Provisional application No. 61/376,371, filed on Aug. 24, 2010.

(51) Int. Cl. H05B 3/02; H05B 1/02

(52) U.S. Cl. 219/497

(57) ABSTRACT

In order to make heat with a wind turbine you must have a heating element with the capacity to withstand prolonged use at high wind speed. With an element of that size at slow wind speeds the wind turbine will not turn or stay in a overloaded or locked position. The present invention a resistive heating control for a wind turbine or any permanent magnetic generator which comprises a control to read the voltage output of the wind turbine and change the resistance of the heating element to match the output of the wind turbine. This is done by putting two equal sized heating elements in series for low wind speed thereby giving us high resistance and low current usage. At mid wind speed one heating element is removed thereby giving us lower resistance and higher current usage. At high wind or maximum output level the second heating element is put back into use in parallel thereby giving us the correct resistance to use all available energy produced by the wind turbine.

### CROSS-REFERENCE TO RELATED APPLICATIONS

This application claims priority to U.S. Provisional patent application No. 61/376,371 filed Aug. 24, 2010 by applicant Edward E Paparelli and entitled resistive heating control for a wind turbine or any permanent magnetic generator.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The present invention relates generally to a resistive heating control for a permanent magnetic generator and, more particularly to a wind turbine.

In order to produce heat from a wind turbine you must have a heating element that is large enough to function properly for prolonged periods of time with high wind, at the maximum output of the wind turbine. With such a large heating element at slow wind speeds the wind turbine will not spin or stay in a overloaded position and not capture all available energy.

### BRIEF SUMMARY OF THE INVENTION

The various embodiments of the present invention substantially mitigate one or more of the disadvantages noted above by changing the resistance of the heating elements according to the voltage level of the wind turbine. The goal is to match the wind turbine output to the heating element resistance. This is done by using two elements connected in series in low wind there by having high resistance and low current usage. At mid wind one element is removed giving us less resistance and more current usage. At high wind the second element is put back in parallel giving us the correct amount of resistance to use all available energy.

### BRIEF DESCRIPTION OF THE DRAWINGS

FIG. 1 is a block drawing showing interconnections of various components used in the first embodiment of my invention. As stated in provisional patent No. 61/376,371

FIG. 2 is a block drawing showing the interconnections of the power switches and the heating elements shown if FIG. 1

FIG. 3 is a block drawing showing the second embodiment of my invention. This is not covered in provisional patent No. 61/376,71

### DETAILED DESCRIPTION OF THE EMBODIMENTS

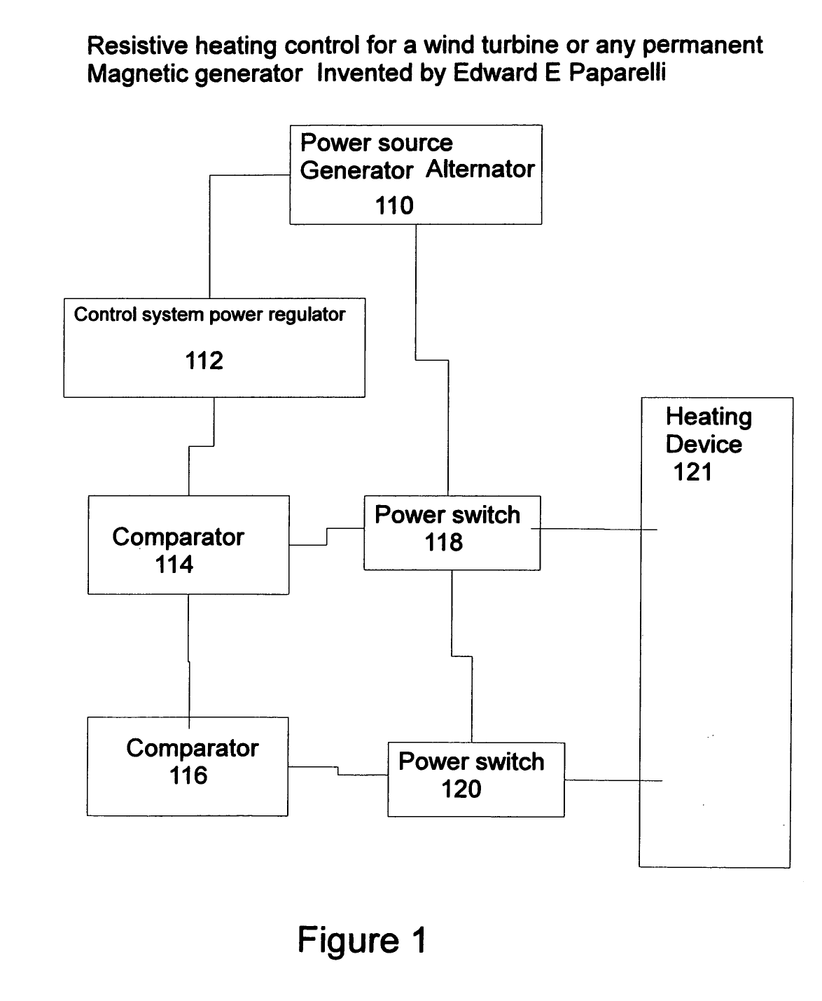

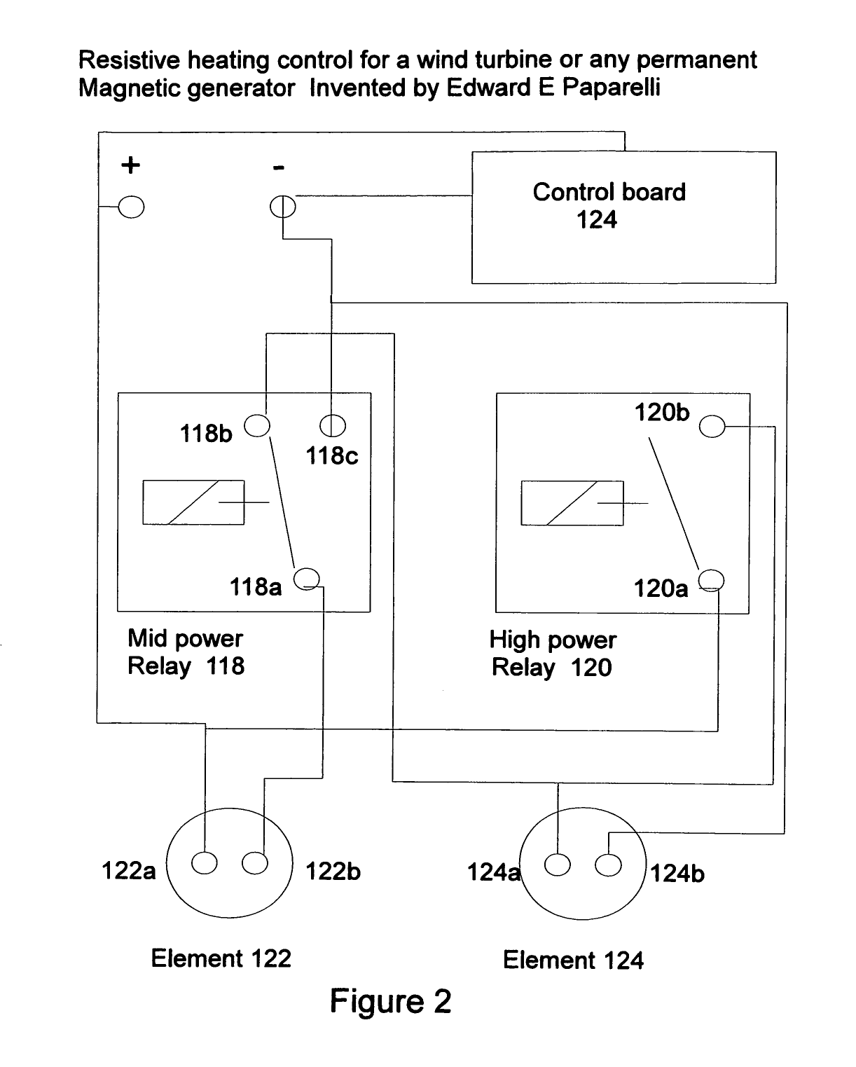

In the first embodiment of my invention shown in (FIG. 1), the power source generator alternator 110 can be any variable voltage power producing device. Example wind turbine, hydro generator provided it supplies direct current to the control. The control system power regulator 112 limits the incoming voltage to produce a control voltage that is read by comparator 114 and 116. The comparators can be set to trip the power switch or relay 118 and 120 at a voltage level compatible with the wind turbine output. (FIG. 1) 112, 114, 116 will be referred to in (FIG. 2) as control board, this will be discussed in greater detail below. 121 (FIG. 1) can be any type of resistive heating device having two elements of the same ohm rating. Example water heater, air type space heater, stove or fireplace.

(FIG. 2) shows a more detailed view of connections between The control board 124, power switch 118, 120 and the heating elements 122, 124. The heating elements have two connections each shown as ref #a or “in” and ref #b or “out”. 118 power switch or referred to in (FIG. 2) as mid power relay would have a normally closed connection 118b and a activated connection 118c. 120 power switch or referred to in (FIG. 2) as high power relay would have a normally open connection 120b.

In the first embodiment the connections are as follows as shown in (FIG. 2). The direct current positive line is connected to the in 122a of element 122, the out of element 122 at 122b is connected to the in 124a of element 124 thru the mid power relay at 118a and 118b. The out of element 124 at 124b is connected to system ground or negative of the direct current power supply. This puts the elements in series when the system is at rest or at a voltage that is below the mid power trip setting.

When the mid power relay 118 is activated the connection between 122b and 124a is broken at 118b and 122b is connected to system ground thru 118c. This puts only element 122 in use there by giving us a lower resistance and more current usage.

when the high power relay 120 is activated a connection is made from 122a or positive direct current thru relay 120 at connection 120a and 120b, there by putting element 124 back into use in parallel with element 122.

The relays and heating elements must be of sufficient size and rating to handle the maximum rated out put of the wind turbine.

The control board 124 (FIG. 2) can be made with standard electronics or a run by a computer based program to activate the appropriate relays and control the drop out point of the relays as the voltage drops when the next stage is started or the voltage drops off from the wind turbine.

In the first embodiment as shown in (FIG. 1) and (FIG. 2) as the control board 124. The system power regulator 112 (FIG. 1) limits the input voltage to a control voltage that can be used to power the coils on the mid power 118 and high power 120 relays and also goes thru the voltage comparators 114 and 116. the voltage comparators 114 and 116 are assemble the same. They consist of a potentiometer to adjust the voltage point at witch the voltage comparator activates and a hysteresis with a potentiometer to control the point at witch the comparator deactivates that is adjustable to a voltage level lower then the activation voltage.

The second embodiment of my invention is an addition to the first embodiment and is meant to be used with all the components of the first embodiment

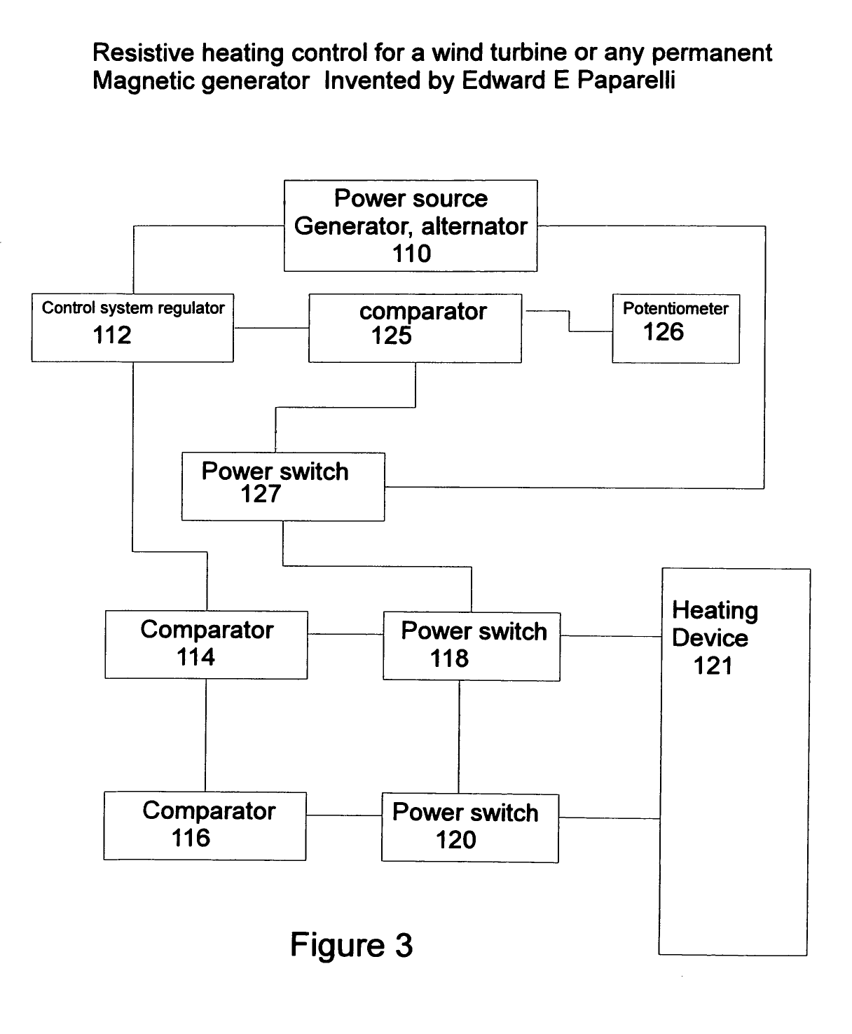

The second embodiment is the addition of adding a third voltage comparator 125 (FIG. 3) with a external mounted potentiometer 126 to adjust the trip point, and a third relay 127 to control the on/off of the heating device. This would allow the wind turbine to free wheel until a set voltage before the heater would turn on. This would also allow the end user to put the heating control in line with a direct current wind/solar battery system and control how much energy they use to make heat.

The embodiments stated above are the basic principle of a three step resistive heating control. A control could be constructed with additional heating elements of varying resistance and corresponding controls to increase the steps at witch the control changes the resistance of the heating device.

1. A resistive heating control for wind turbine or any permanent magnetic generator comprising:
A control that reads the voltage level of said wind turbine output and activates relay's at an adjustable voltage level. And have the means to deactivate the said relays at a voltage level lower than said activation voltage level.
A set of two resistive heating elements of the same rating connected in series thru the normally closed connection of the mid power relay. Thereby putting the heater in high resistance or low current usage for low wind speeds. At mid wind speed the the said mid power relay activates and removes one heating element leaving one said element in use thereby decreasing the resistance and increasing the current usage. At high wind speeds the high power relay activates and puts said second element back into use. Thereby matching the said heating elements resistance to the said wind turbine maximum output.

2. The system of claim 1 wherein said control is further adapted to control the voltage level at witch the heater will turn on and off comprising of:
A third comparator with a externally mounted potentiometer and a third said relay.
